(19) United States
(12) Patent Application Publication
(10) Pub. No.: US 2009/0322582 A1
(43) Pub. Date: Dec. 31, 2009

(54) SYSTEM AND METHOD FOR DUAL MEDIA CONTROL OF REMOTE DEVICES

(75) Inventors: James Baugh, Denver, CO (US); Paul F. Josephson, Firestone, CO (US); Joseph E. Kovach, Brighton, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: HUNTER DOUGLAS INC., Upper Saddle River, NJ (US)

(21) Appl. No.: 12/439,028

(22) PCT Filed: Aug. 23, 2007
(86) PCT No.: PCT/US2007/076684

§ 371 Date: Feb. 26, 2009

Related U.S. Application Data
(60) Provisional application No. 60/824,503, filed on Sep. 5, 2006.

(51) Int. Cl. G08C 19/12

(52) U.S. Cl. 341/176

(57) ABSTRACT

A remote for controlling devices and communicating data to and from such devices using both IR and RF signals. The remote control may transmit a first signal to one or more devices which, in turn may each transmit a reply signal to the remote. Each reply signal typically, although not necessarily, contains an identification of the transmitting device and the signal strength of the first signal, as detected at the device. The remote may employ this information to determine which device is closest and transmit commands accordingly.

### CROSS-REFERENCE TO RELATED APPLICATION

The present invention claims priority under 35 U.S.C. § 119(e) to U.S. Provisional Patent Application Ser. No. 60/824,503, titled “System and Method for Dual Media Control of Remote Devices” and filed on Sep. 5, 2006, the entirety of which is incorporated herein by reference.

### INVENTIVE FIELD

The various embodiments of the present invention relate to wireless automation systems. More specifically, apparatus, processes, systems and methods for using a remote control device to control one or more battery powered and/or line powered devices is provided.

### BACKGROUND

Systems for controlling devices distributed throughout an office building, factory, home or other location have become desirable over the past several years. Such systems commonly utilize a remote control to directly control the operations and functions of one or more devices. The devices can be connected to and used to control one or more appliances (i.e., lights, shades, fire sensors, audio/visual equipment, security systems and others). Further, repeaters, amplifiers, centralized controllers and other components can be utilized in the system to create a network of devices that desirably can be controlled from any location, at any time, using a remote control device.

Remote control device commonly emit infra-red signals (“IR”) or radio frequency (“RF”) signals to send commands and/or other information to a device. However, many implementations for home/office automation systems require the placement of the devices in close proximity to each other. In some applications, devices are configured to utilize the same IR and/or RF signals, thereby making control of an individual device difficult. Thus, a system and method is needed whereby any number of proximally located devices can be selectively controlled using a remote control.

### SUMMARY

The various embodiments of the present invention provide systems and methods for controlling any number of devices using a single remote control device that communicates data to and from such devices using both IR and RF signals. A remote control may transmit a first signal to one or more devices which, in turn may each transmit a reply signal to the remote. Each reply signal typically, although not necessarily, contains an identification of the transmitting device and the signal strength of the first signal, as detected at the device. The remote may employ this information to determine which device is closest and transmit commands accordingly.

One embodiment of the present invention takes the form of a method for controlling a remote device, including the operations of: transmitting a first outbound signal to at least a first and second device; receiving a first reply signal from the first device, the reply signal comprising a first identifier and a first signal strength; receiving a second reply signal from the second device, the second reply signal comprising a second identifier and a second signal strength; comparing the first signal strength to the second signal strength; in the event the first signal strength exceeds the second signal strength, communicating a second outbound signal to the first device; and otherwise, communicating the second outbound signal to the second device.

Another embodiment takes the form of a method for operating a device, including the operations of: receiving a first signal; measuring a signal strength of the first signal; generating a signal strength indicator corresponding to the measured signal strength of the first signal; and transmitting a reply signal including a device identifier identifying the device and the signal strength indicator.

Still another embodiment takes the form of a remote control for a device, including: a processor; a first transmitter operably connected to the processor for transmitting a first signal; a second transmitter operably connected to the processor for transmitting a second signal; a first receiver operably connected to the processor for receiving a third signal comprising a first identifier identifying a first device transmitting the third signal; and a first logic module executed by the processor to encode a second identifier into the second signal.

### DESCRIPTION OF THE FIGURES

FIG. 1 is a schematic diagram illustrating one embodiment of the use of dual media control of remote devices.

FIG. 2 is a block diagram illustrating one embodiment of a remote control for use in the various embodiments of the present invention.

FIG. 3 is a block diagram illustrating one embodiment of a device for use in the various embodiments of the present invention.

FIG. 4A is a flow diagram illustrating a process for use in selectively communicating data from a remote control to a device in accordance with at least one embodiment of the present invention.

FIG. 4B is a flow diagram illustrating a process for use in selectively communicating data from a remote control to a device in accordance with at least one embodiment of the present invention.

FIG. 5 is a flow diagram illustrating a process flow for use of the remote control to track a moving object in accordance with at least one embodiment of the present invention.

FIG. 6 is a schematic diagram illustrating a system utilized to detect and/or track a tracked object in accordance with at least one embodiment of the present invention.

FIG. 7 is a schematic diagram illustrating a second utilized to detect and/or track a tracked object in accordance with at least a second embodiment of the present invention.

### DETAILED DESCRIPTION

The various embodiments of the present invention provide systems and methods for controlling any number of devices using a single remote control device that communicates data to and from such devices using both IR and RF signals. The various embodiments of the present invention can be configured to utilize various communications protocols, such as those that minimize communication messages, so as to reduce the energy demands upon battery operated devices. One example of such a communications protocol is described in U.S. Patent Application Ser. No. 60/662,959, entitled “System and Method for Adaptively Controlling a Network of Distributed Devices,” which was filed on Mar. 18, 2005 and is incorporated herein by reference in its entirety. Other communications protocols can also be used with the various embodiments of the present invention.

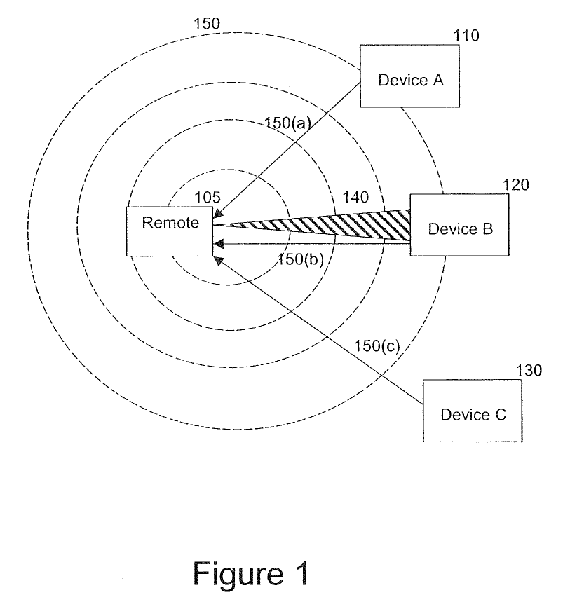

As shown in FIG. 1, for at least one embodiment of the present invention, a system is provided wherein a remote control 105 is configured to transmit both IR signals and RF signals to one or more devices. The one or more devices, such as devices 110, 120 and 130, can be connected, directly or indirectly, to one or more appliances (not shown), such as new or existing coverings for an architectural opening (for example, POWERRISE window coverings manufactured by Hunter Douglas Inc.), audio/video equipment, industrial process equipment, security system components, or otherwise. The remote control 105 can be positioned at various locations relative to the devices 110/120/130 and can be stationary or mobile for any given period of time. Desirably, when in use, the remote control 105 is positioned such that a device is within the operating range of the remote control, wherein the operating range is determined and/or influenced by the output power, the signal characteristics, the ambient environment and other factors which influence, positively or negatively, the transmission, propagation and reception of a transmitted signal.

The devices 110/120/130 are configured to include both an IR receiver and an RF receiver and can be located at varying distances relative to each other and/or to the remote control. The devices 110/120/130 can also be stationary or mobile, as desired for any given implementation of the present invention.

The remote control 105 transmits one or more IR signals 140 (as shown by the dashed lines). The IR signals 140 propagate from the remote control 105 and, desirably, towards the devices 110/120/130. The IR signals 140 can be configured to propagate at any desired degree or angle of beam dispersion, but typically are focused in a relatively narrow beam pattern of approximately 15 degrees as shown in FIG. 1. It is to be appreciated that by adjusting the beam dispersion angle, a desired beam pattern over a given area can be achieved. That is, an IR beam can be more narrowly focused, by lenses, apertures or otherwise, so that it can focus on an individual device rather than projecting on multiple devices over a large area. In one embodiment of the present invention, a relatively narrow beam angle of approximately 30 degrees is utilized.

For other embodiments, the remote control 105 can be configured such that an IR signal can be transmitted in a scanning, sweeping or steering manner. That is, the IR beam can be initially transmitted, for example, such that it is first transmitted in a direction proximate to device A 110, and then steered towards device B 120 and then towards device C 130. It is to be appreciated that using such well known beam steering/scanning/sweeping techniques, the relative position of one or more devices 110/120/130 to the remote control 105 can be detected. The distance of a device 110/120/130 from the remote 105 can also be determined.

In another embodiment, the remote control 105 transmits IR signals at one or more frequencies. For example, each of a plurality of devices can be configured to receive and respond to IR beams of a particular frequency or over a range of frequencies. The remote control 105 can be configured to transmit IR signals, intermittently or at the same time, at one or more desired frequencies and thereby communicate the data contained in the IR signal to multiple devices, tuned to different IR frequencies, at substantially the same time. In one embodiment, the remote control 105 is configured to transmit IR signals on three different channels. These emissions can occur independently, substantially simultaneously or simultaneously—as desired for a specific implementation or use of the remote control 105.

The remote control 105 can also be configured to transmit RF signals 150 at any single or multiple desired frequencies. The RF signals can be transmitted in any of various formats such as broadcast, multicast, narrowcast, point-to-multipoint, point-to-point, unicast, or otherwise. The RF signals can also be multiplexed onto a carrier so that multiple information signals are separately, or otherwise, transmitted to one or more devices.

The remote control 105 can also be configured to receive IR and/or RF signals transmitted by one or more devices 110-120-130. In one embodiment, the remote control 105 includes an RF transceiver and antenna that is configured to transmit and receive RF signals to and from devices 110/120/130, respectively. The transceiver can be configured to detect and receive RF signals communicated on one or more RF frequencies, as desired. That is, each device 110/120/130 can be configured to communicate on the same or separate RF frequencies. When communicating on the same frequencies (whether IR, RF or otherwise), addressing schemes can be used to distinguish between devices.

The various embodiments of the remote control can be configured to include one or more grouping capabilities. For example, multiple individual RF groupings can be provided, whereby each group can be programmed (on the remote control) to emit RF signals specific to that group. Correspondingly, the devices associated with the one or more groups can be programmed to receive and recognize RF signals associated with the given group(s). One of the groups can include an “all” functionality, whereby all of the groups programmed into a remote are activated at once. It is to be appreciated that the selection of one or more groups can be accomplished by using one or more buttons provided on the remote control 105 (wherein each button is associated with at least one given group), using a push and hold technique (wherein the length of time a single button is held indicates which group is selected), and the like.

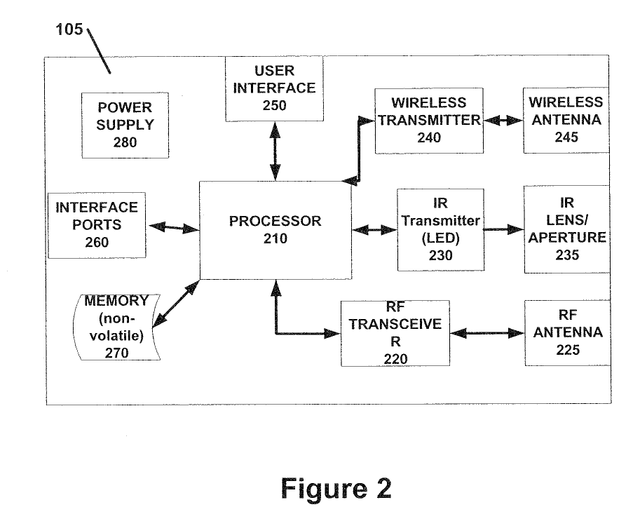

Referring now to FIG. 2 for one embodiment of the present invention, the remote control 105 can be configured to include the following components: a processor 210; an RF transceiver 220 connected to RF antenna 225; an IR transmitter 230 connected to IR lens or aperture 235; an optional wireless transmitter 240 connected to wireless antenna 245; a user interface 250 (which can include in various embodiments, for example, separate LEDs to indicate the emitting of an RF signal or an IR signal; separate buttons for selecting program modes, a separate programming button to initiate the programming of one or more devices, master resets and the like); one or more optional interface ports 260; a data storage and/or memory device 270; and a power source 280 (for example, one or more batteries). More specifically, for one embodiment, the processor 210 is a PIC16F870, manufactured by Microchip. The RF transceiver 220 is desirably a NRF24L01, manufactured by NordIC and is configured to operate over a frequency range of 2.4 GHz at an output power of up to 4 dBm. The IR transmitter is an LED, such as MIE544A2 manufactured by UNI, emitting infrared signals at an output power of 10 mW and at a frequency of 40 kHz. For at least one embodiment of the present invention, RF transceiver and IR emitter are connected to one or more antennas, lens, apertures, wave guides or the like, as represented in FIG. 2 by antenna 225 and lens/aperture 235 (collectively, “antennas”). The remote control 105 can also be configured such that it operates over any given range. For example, the remote control can be configured to transmit a focused IR signal over a first given distance while transmitting an RF signal over a second given distance, and vice versa. Although the RF signal is generally capable of being transmitted further than the IR signal in most embodiments (for example, 200 feet versus 30 feet), it is conceivable that certain embodiments may be configured to transmit the IR signal further than the RF signal. Accordingly, the ranges and distances set forth herein are intended by way of example rather than limitation.

A wireless transmitter 240 and associated antenna 245 can be optionally included in the remote control 105. The wireless transmitter can be configured to operate over any desired frequency range and in conformance with one or more wireless standards, such as Bluetooth, 802.11a,b,g, or other communications standards. The wireless transmitter 240 desirably provides wireless communications capability between the remote control 105 and other communications systems, such as those associated with a broadband or wireless network.

The remote control 105 commonly is configured to include a user interface 250. The user interface 250 can include one or more user output components, such as a liquid crystal display, that can be used to provide the user with information concerning the operation and/or status of the remote control 105, a device 110-120-130 in communication with the remote control, a network interconnecting two or more devices, or the like. Examples of user output devices include, but are not limited to, liquid crystal displays, sound output modules, and/or other types of visual indicators. The remote control 105 commonly is also configured to include one or more user input components such as buttons, thumb scroll wheels, touch screens, microphones, and others input components commonly known in the art.

The remote control 105 can be configured to include one or more interface ports 260. The interface ports, can be utilized to connect the remote control 105 to one or more computer or telecommunications devices. Examples of interface ports include those compatible with standards such as those for universal serial bus, fire wire (i.e., IEEE 1394), SCSI, RS-232, RJ-11, RJ-45, RS-485, CAN bus and others.

The remote control 105 can be configured to include a non-volatile memory 270 or data storage device (hereafter, “storage device”). Volatile memory can also be included with or separate from the processor 210. Examples of suitable storage devices that can be used with the various embodiments of the remote control 105 include, but are not limited to: flash memory; electrically erasable programmable read only memory (EEPROM); magnetic memory devices (e.g., magnetic tape and magnetic drums); optical memory devices (e.g., compact discs); and non-volatile random access memory (NVRAM). The storage device 270 can be configured to store one or more routines for configuring devices, such as by scene or setting, addresses for devices, and other information used by the processor 210 or to be communicated to a user.

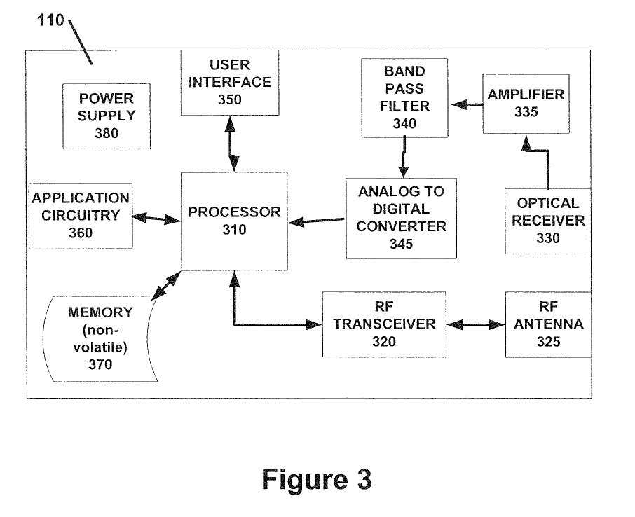

Referring now to FIG. 3, a schematic representation of a device 110 is shown for one embodiment of the present invention. The device can be configured to include: a processor 310; an RF transceiver 320 and antenna 325; an optical receiver 330; an amplifier 335; a bandpass filter 340; an analog to digital converter 345; an optional user interface 350; application circuitry 360; memory 370; a power supply 380 and other components.

More specifically, the device can be configured to include a processor 310 such as a PIC16F870, manufactured by Microchip. In one embodiment, the RF transceiver 320 is a NRF24L01, manufactured by NordIC and is configured to operate over a frequency range of approximately 2.40 to 2.48 GHz at an output power of up to 4 dBm. The optical receiver 330 can be configured to receive optical signals, such as those emitted by the remote control 105, and in one embodiment is anPNZ323B manufactured by Panasonic. The optical receiver 330 is connected to an amplifier 335, such as a TLV2371 manufactured by Texas Instruments. The amplifier amplifies the electrical signals generated by the optical receiver 330 based upon a received IR signal transmitted by the remote control 105. The amplifier 335 is connected to a bandpass filter 340 which is tuned to isolate only those signals representative of a received IR signal over the range of 45 kHz-55 kHz. The output of the bandpass filter 340 is communicated to an analog to digital converter 345 such as the analog to digital converter on-board the Microchip PIC16F870 processor, whereupon converting the received signal into a digital format, the signal is provided to the processor 310.

The device also can be configured to include an optional user interface 350. In certain embodiments, a user interface 350 can be provided which enables a user to operate the device directly by, for example, depressing or selecting one or more buttons. Further, the user interface 350 can be configured to include one or status indicators, such as LEDs, audible indicators, or the like.

Application circuitry 360 can also be included in the device 110. For example, various registers, relays, switches, input/output ports or the like can be configured to communicate with the processor 310. The application circuitry 360 can also be configured to include interfaces for one or more sensors. Such sensors can be included in an appliance, such as a position sensor for a window covering, or they can be provided separately, such as a motion sensor for a security system. Additionally, it is to be appreciated that the device 110 can be included within or separate from an appliance. Also, a device 110 can be configured to interface (and/or control) one or more appliances, one or more devices, one or more networks, combinations of the foregoing, or the like. Thus, the application circuitry 360 desirably provides those interfaces necessary to enable the device 110 to interact with a given appliance, device, network, system or the like.

Memory or non-volatile storage can also be provided with the device 110. Any of the foregoing examples of memory/non-volatile storage can be used. Additionally, networked or remote storage can be used in the various embodiments of the present invention.

A power supply 380 is included with the device 110. The power supply can condition, as necessary, power provided by line, low voltage battery or otherwise (and combinations thereof). The type of power supply used can vary from device to device, system to system and in accordance with any desired embodiment. For example, some devices in a system implementing an embodiment of the present invention can be line powered, while other devices are battery powered. Similarly, devices can powered by solar, wind or otherwise. In at least one embodiment, the device is configured to utilize a maximum of 100 microAmps on average. As discussed below, such low power usage can be accomplished by configuring the device to function predominantly in a “sleep” mode, wherein the optical receiver, amplifier, and related components are inactive except when activated upon the receipt, by the device, of an RF signal. In alternative embodiments, the device may awaken when an IR signal is received instead.

For at least one embodiment, the device can be configured to be compatible with existing receiving devices used on appliances such as Hunter Douglas Corporation's POWERRISE and/or POWERGLIDE window coverings. The device can be configured to operate universally with various types of appliances. DIP switches, or the like, can be included in the device and used to specify which of any given number of appliances a given device is compatible. For example, when used in conjunction with window coverings manufactured by Hunter Douglas, the device can include a selector switch which, upon selection of the appropriate pins, configures the device for operation with DUETTE, SILHOUETTE, VIGNETTE, POWERGLIDE, POWERTILT and other types of window coverings. That is, desirably the device of the present invention can be readily connected to those appliances already including an IR or RF receiving device. In one embodiment, a four pin conductor can be used to facilitate the adaptability of the device to existing appliances. In other embodiments, two, six, eight and other pin conductors can be used. Likewise, the device can be configured to fit within existing openings in appliances, such as those currently occupied by IR or RF receiving devices. Further, the device can be configured to be compatible with existing remote controls and/or with the scope of the various embodiments of remote controls described herein.

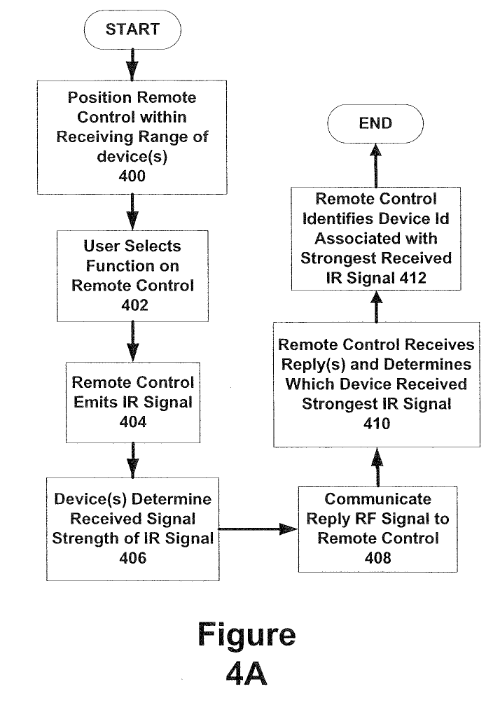

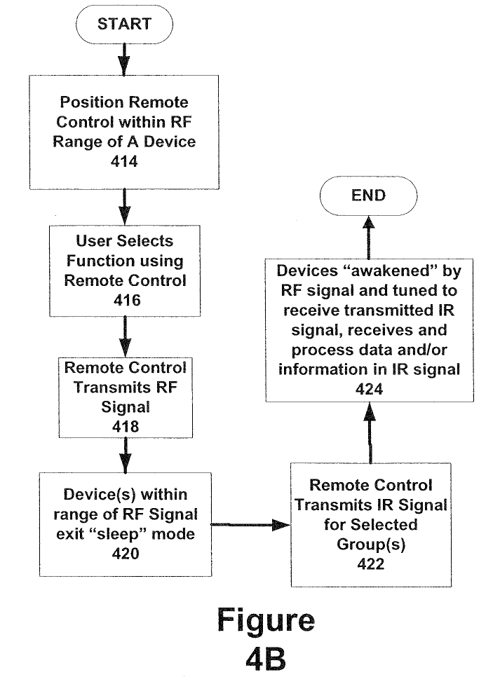

Referring now to FIG. 4a, a flow diagram depicting one implementation of an embodiment of the present invention is shown. The process by which a remote control 105 utilizes the IR and RF transmission mediums to communicate with one or more devices 110/120/130 starts, for one embodiment of the present invention, with positioning the remote control 105 within the receiving range of one or more devices (Operation 400). The receiving range of a device for an IR and an RF signal will vary depending upon the wavelength of the communications signal utilized, the transmitting power of a remote control, the sensitivity of a device, and the surrounding environment. For example, RF signals commonly can be communicated through walls, but, IR signals require a direct line of sight between the transmitter and the receiver. Thus, it is to be appreciated that a user of a remote control provided in conformance with an embodiment of the present invention, is positioned proximate to one more devices such that a direct line of sight connection can be established between the remote control's IR transmitter and a receiver on one or more devices. It should also be noted that, with respect to the disclosure herein and particularly FIGS. 4A and 4B and the associated text, certain embodiments may employ a RF signal in lieu of the IR signal and vice versa.

Upon positioning the remote control 105 within the receiving range of one or more devices 110/120/130, a user can select a function on the remote control 105 (Operation 402). For example, a remote control 105 can be configured such that a “down” button, when depressed, results in a command being communicated to a device that results in a window covering being lowered. Similarly, an “up volume” button might result in the volume of a audio system being increased. Further, a “mode” or “scene” button can be programmed so that a number of devices control any number of appliances to achieve a desired ambience.

Upon the selection of a function, the remote control 105 transmits an IR signal (Operation 404). As shown in FIG. 1, when a particular device, such as device “B,” is desired to be controlled, the remote control 105 can be pointed in the immediate direction of the device. Further, the transmitted IR signal travels to each device 110/120/130 within range and in the direction of the emitted IR field pattern 140. Upon receiving and detecting the IR signal, each device determines the received signal strength of the IR signal (Operation 406). For example, as shown in FIG. 1, device “B” 120 being closer to the remote control 105, would receive the IR signal 140 at a greater signal strength than device “A” 110 or device “N” 130. As is commonly known and appreciated, the atmosphere and/or other environmental conditions commonly contribute to the attenuation of the IR signal as it travels ever farther away from a emitter, such as remote control 105.

Each device receiving the IR signal from the remote control, then transmits a reply signal (as shown in FIG. 1 by indicators 150(a), 150(b) and 150(c)) to the remote control 105 (Operation 408). In the reply signal, for at least one embodiment of the present invention, each device desirably communicates a device identifier, such as number or character code, and the received signal strength for the previously transmitted IR signal, from the remote control.

Upon receipt of each of the received replies, the remote control 105 compares the reported received signal strengths in each of the reply RF signals 150(a), 150(b) and 150(c) and, based thereon, determines which device 110/120/130 received the strongest IR signal—hereafter the “selected device” (Operation 410). In the above example, since device “B” 120 is closest to the remote control 105, it received and detected the strongest IR signal and reported its received IR signal strength to the remote control in reply 150(b), thus, device “B” in this example is the “selected device.”

The remote control 105, upon having identified the selected device, extracts the previously communicated device ID from the reply communicated by the selected device (Operation 412). That is, in the above example, the remote control 105 extracts the device ID from reply 150(b).

Commands, data and/or other information are then communicated from the remote control 105 to the device having reported the strongest received IR signal strength (i.e., device “B” 120) (Operation 414). Exclusivity of commands between the remote control 105 and the selected device 120 can be accomplished by embedding a the device “B” device identifier in each command. Likewise, the remote control 105 can verify that acknowledgements, data and/or other information are communicated from the selected device, i.e., device “B,” by also verifying the device ID communicated in received RF signals and by acting upon only those for the selected device.

Referring now to FIG. 4B, another embodiment of a method for using a dual media remote control device is shown. In this embodiment, the devices 110/120/130 are operated in a power save mode, whereby various aspects of the control electronics for the device (for example, the RF transceiver) are in a “sleep” mode and are programmed to periodically, versus continuously, search for and receive RF and/or IR signals. By periodically, instead of continuously, activating the RF transceiver, it is to be appreciated that significant power savings can occur, which can lead (for example) to longer battery life in battery powered devices. As shown, this embodiment includes a user positioning the remote control so that one or more devices are within the RF range of the remote (Operation 414). As discussed above for one embodiment, the RF range of a remote is approximately 200 feet. Other ranges, however, can be supported (and corresponding components utilized) as desired for a particular implementation.

Upon placing the RF remote within the range of one or more devices, the operations continue with a user selecting, via the remote control, a function to be performed by the one or more devices. (Operation 416) As described above, the remote control desirably includes a user interface which enables the user to selectively control one or more devices, for example, by the depressing of a group button or the like. Upon selection of the function, the remote control transmits an RF signal. (Operation 418) If a particular group button is first depressed, the remote control 105 transmits an RF signal carrying the command corresponding to the depressed control button as well as a group identifier. Only those devices in the group matching the group identifier will execute the command.

As is commonly appreciated, RF signals do not require line of sight between a remote and a device to facilitate the communication of data and/or information between the same. RF signals can travel through furniture, walls and the like. Thus, the RF signal can be used, in this embodiment, as an indiscriminate “wake-up” signal, where devices within RF range of the remote exit “sleep” mode upon reception of the RF signal. (Operation 420) In this embodiment, the RF signal transmitted by a remote can be used to “wake-up” all or a selected one or more devices within range of the remote. Device identifiers, group identifiers, addresses or the like can be transmitted, as desired, in the RF signal such that upon receipt of the same, only those devices receiving their designated device ID, group ID or the like, exit “sleep” mode.

The process further includes the remote control transmitting an IR signal. (Operation 422) In at least one embodiment, the time lapse between the transmitting of the RF signal and the transmitting of the IR signal is desirably minimized, to the extent reasonably possible, in order to minimize the amount of time during which the control electronics are in the “awake” mode. In other embodiments, such as those using line powered devices, longer time period can elapse between the transmitting of the RF signal and of the IR signal, as desired.

The IR signal transmitted by the remote, in Operation 422, can also and/or alternatively include device identifiers, group identifiers, addresses or the like (collectively, “identifiers”). These identifiers can be associated with a group button (for example, one provided on a user interface) and transmitted in the IR signal such that upon receipt of the same, those devices receiving their designated device ID, group ID or the like will process any data and/or information communicated by the remote control in the IR signal. The transmitted data can include one or more commands for one or more devices to perform a given action or actions.

Thus, it is to be appreciated that the foregoing processes enable a user of a remote control to selectively command a device, when a plurality of devices are within the range and orientation of an IR or RF signal generated by a remote control. Further, the various embodiments of the present invention, as set forth above with respect to the described exemplary processes, enable a user to command a device without having to know the device's ID or other identifier in advance. Further, the foregoing processes enable a user to remotely command a device, using the before mentioned remote control, without having to depress a button, for example, on or connected to the device. It is to be appreciated that this feature can be extremely beneficial when, for example, a user desires to adjust just one of a plurality of closely spaced window coverings to which access to a device used to adjust a window covering is problematic or non-practical.

The various embodiments of the present invention also include a methodology by which group functions and similar functions can be programmed into a remote control and a corresponding device. In one embodiment, this programming includes the operations of configuring the remote in programming mode (for example, by selecting a programming button), pressing a desired group function button, and pointing the remote at the desired device while an IR signal is being transmitted. Desirably, these operations occur in conjunction with the device entering programming mode (for example, by the depressing of a programming button on the device during installation). Upon receiving the IR signal, the device is then programmed to respond only to RF signals corresponding to the assigned group in the present programming mode. Further, multiple devices can be programmed to respond to a single RF signal by repeating the above process for each device, separately or in mass.

As described above, at least one embodiment of the present invention includes a remote control which enables a user to command a selective one (or many—if they all have the same device ID) of multiple devices by using a first signal, such as an IR signal, to initiate a reply from those devices within range of the remote control, and by using a second signal, such as an RF signal to selectively communicate with a device having received, detected and reported (in the reply) the strongest first signal strength.

The above description also provides for a remote control which enables a user to identify and selectively control one or more devices, while conserving power in the device(s), by using an RF signal as a trigger to one or more devices to exit “sleep” mode, and an IR signal which provides data instructing one or more devices to perform one or more functions.

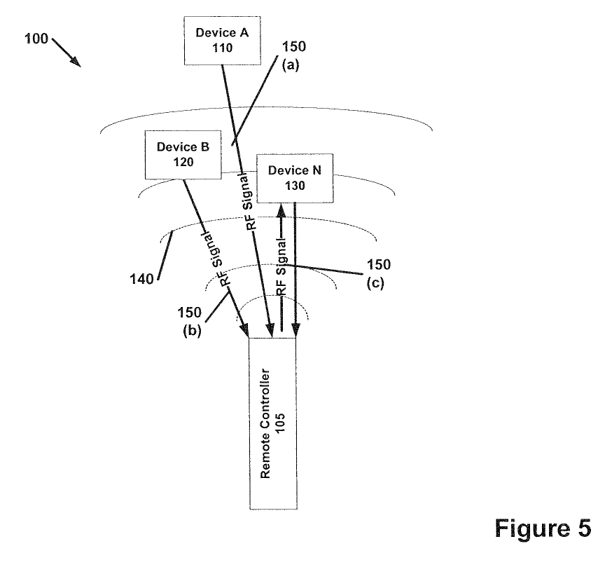

Further, it is to be appreciated that by rotating the remote control 105, as practical, relative to the detected devices, and emitting a second IR signal, a spatial orientation of the devices can be obtained (See FIG. 5). For example, a mapping of the relative position of the devices 110/120/130 based upon the first IR signal (FIG. 1), indicates that device “B” was closer to a fixed position (the position of the remote control 105 when it emitted the first IR signal), then either of devices “A” or “C.” Similarly, when the remote control 105 is moved (for example, towards the bottom of FIG. 1) such that device “C” is now directly in its line of sight (as shown in FIG. 5) of the remote control 105, a comparison of received signal strengths would indicate that device “C” now has received the strongest signal strength, while device “B” is second strongest and device “A” is weakest. This signal strength reading, in view of the first reading, can be interpreted as an indication that device “B” is closer to device “C” then device “A” is to device “C.” Further, this process can be repeated until sufficient information is obtained so that the processor in the remote control, using triangulation or other known position determination techniques, can create a mapping of the relative position of each device relative to each other device and relative to a given remote control position. Thus, by using a query and reply system, that uses known location and orientation information for a remote control, repeated at different locations, orientations and the like, a mapping of device locations in a network or distribution of devices can be generated without having to physically verify the precise location and/or orientation of each device.

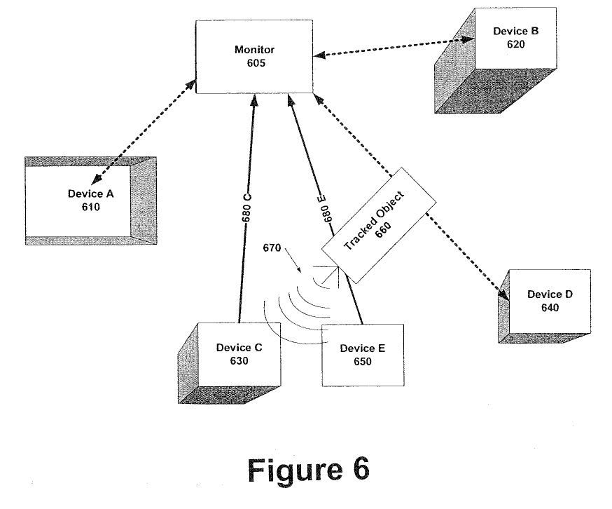

Further it is to be appreciated that the various embodiments of the present invention can also be utilized to track the position of a moving object. As shown for example in FIG. 6, a plurality of devices 610-650 can be distributed throughout a space, wherein the shaded portion for each device indicates a relative height above or below a plane formed by the surface of the paper in a three dimensional space. For example, in FIG. 6, device “B” 620 is significantly above the plane formed by the paper, device “A” 610 is below the plane, device “E” 650 is located on the plane, and so forth. Further, the location of each device (A-E) can be known and fixed. A monitor 605 is in communication with each device, on an as needed basis. A tracked object 660, for example a radio frequency identifier (“RFID”) encoded product, moves throughout the three dimensional space. While the tracked object 606 moves throughout the space it periodically outputs a first signal 670. The first signal 670 is received by the devices within its transmission path. As shown in FIG. 6, device “C” 630 and device “E” 650 both receive the first signal 670. Each of these devices determine the strength of the received first signal and communicate the same to monitor 605, in second signals 680(C) and 680(E). The monitor 605 utilizes the received second signals to determine the location of the tracked object 660, relative to those devices reporting the reception of the first signal.

While FIG. 6 shows only two devices receiving the first signal, it is to be appreciated that the range and spread of a first signal can vary. Further, the number of devices and relative location of devices with respect to each other can also vary so that more or fewer devices detect a position of a tracked object at any given time, for any given transmission of a first signal. That is, the system can be scaled as desired to provide any quality level of positional accuracy determinations.

Further, FIG. 6 shows the second signal being communicated to the monitor 605. It is to be appreciated, however, that the second signal can be communicated to the tracked object 660 from each of the devices receiving the first signal. Desirably, the second signal, in such an embodiment, includes an indication of the location of the device generating the respective second signal. Using such information, the tracked object 660 desirably can determine its own position and/or orientation.

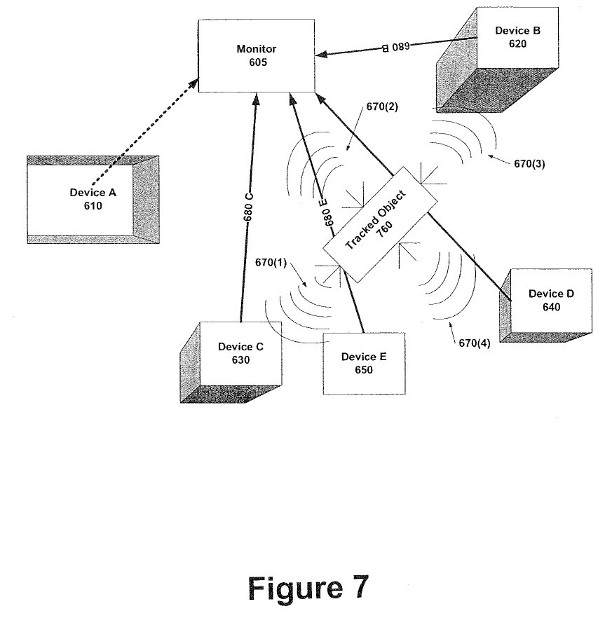

Referring now to FIG. 7, in another embodiment of the present invention, the tracked object 760 can be configured to include more than one transmitter of a first signal. As shown for this embodiment, the tracked object 760 includes four transmitters of four first signals 670(1), 670(2), 670(3) and 670(4), respectively. As shown, the devices variously receive the transmitted first signals and transmit second signals 680(b), 680(c), 680(d) to the monitor 605. It is to be appreciated that such an embodiment generates more position information and thereby provides for greater accuracy in determining the position, rate of movement, track and the like of a tracked object. Further, it is to be appreciated that a tracked object can utilize omni antennas, which transmit the first signal in all directions and thereby eliminate the need for the multiple first signals.

Therefore, it is to be appreciated that the various embodiments of the present invention utilize a dual media signal system to detect and control remote devices and/or to track and/or determine the position of a tracked object. While the present invention has been described above with respect to various system and process embodiments, it is to be appreciated that the present invention is not so limited and includes those systems and methods that utilize dual media control as covered by the scope and breadth of the following claims.

1. A method for controlling a remote device comprising:
transmitting a first outbound signal to at least a first and second device;
receiving a first reply signal from the first device, the reply signal comprising a first identifier and a first signal strength;
receiving a second reply signal from the second device, the second reply signal comprising a second identifier and a second signal strength;
comparing the first signal strength to the second signal strength;
in the event the first signal strength exceeds the second signal strength, communicating a second outbound signal to the first device; and
otherwise, communicating the second outbound signal to the second device.

2. The method of claim 1, wherein the second outbound signal includes an identification of the device to which the second outbound signal is communicated.

3. The method of claim 2, wherein:
the first identifier identifies the first device;
the first signal strength indicates the strength of the first signal as received at the first device;
the second identifier identifies the second device; and
the second signal strength indicates the strength of the first signal as received at the second device.

4. The method of claim 1, wherein the first reply signal and second reply signals are radio frequency signals.

5. The method of claim 1, wherein:
the first signal is sent at a first frequency; and
the second signal is sent at a second frequency different than the first frequency.

6. The method of claim 5, wherein the first outbound signal is an infrared signal and the second outbound signal is a radio frequency signal.

7. The method of claim 1, wherein:
the second outbound signal includes a group identifier;
the second outbound signal is received by the first device and the second device; and
the second device is a member of a group corresponding to the group identifier, thereby permitting communication of the second outbound signal to the second device.

8. A method for operating a device, comprising:
receiving a first signal;
measuring a signal strength of the first signal;
generating a signal strength indicator corresponding to the measured signal strength of the first signal; and
transmitting a reply signal including a device identifier identifying the device and the signal strength indicator.

9. The method of claim 8, further comprising:
receiving a second signal containing a group identifier;
determining if the device is a member of the group corresponding to the group identifier; and
operating the device only if the device is a member of the group corresponding to the group identifier.

10. The method of claim 9, wherein the group identifier is identical to the device identifier.

11. The method of claim 9, further comprising waking the device from a sleep mode upon receipt of the first signal.

12. The method of claim 11, wherein:
the first signal is one of the group comprising an infrared signal and a radio frequency signal; and
the second signal is the other of the group comprising an infrared signal and a radio frequency signal.

13. The method of claim 11, wherein the device is a covering for an architectural opening.

14. The method of claim 13, wherein the covering is a window shade.

15. A remote control for a device, comprising:
a processor;
a first transmitter operably connected to the processor for transmitting a first signal;
a second transmitter operably connected to the processor for transmitting a second signal;
a first receiver operably connected to the processor for receiving a third signal comprising a first identifier identifying a first device transmitting the third signal; and
a first logic module executed by the processor to encode a second identifier into the second signal.

16. The remote control of claim 15, wherein the second identifier is a group identifier corresponding to a group including the first device.

17. The remote control of claim 15, wherein:
the third signal further comprises a first signal strength indicating a strength of the first signal as received at the first device;
the first receiver is further operative to receive a fourth signal transmitted by a second device, the fourth signal comprising:
a second identifier identifying the second device; and
a second signal strength indicating a strength of the first signal as received at the second device.

18. The remote control of claim 17, further comprising a second logic module executed by the processor operative to determine the greater of the first signal strength and second signal strength, thereby yielding a greater signal strength.

19. The remote control of claim 18, wherein:
the first logic module receives the greater signal strength from the second logic module; and
the second identifier identifies which of the first and second devices correspond to the greater signal strength.

20. The remote control of claim 15, wherein:
the first signal is one of the group comprising an infrared signal and a radio frequency signal; and
the second signal is the other of the group comprising an infrared signal and a radio frequency signal.
